(19) United States
(12) Patent Application Publication
(10) Pub. No.: US 2008/0019136 A1
(43) Pub. Date: Jan. 24, 2008

(54) LIGHT UNIT WITH A LIGHT-EMITTING DIODE WITH AN INTEGRATED LIGHT-DEFLECTING BODY

(75) Inventors: Jens Mertens, Esslingen (DE); Gunther Holzmacher, Asperg (DE); Jochen Kunze, Moers (DE)

Correspondence Address: REISING, ETHINGTON, BARNES, KISSELLE, P.C., P O BOX 4390, TROY, MI, 48099-4390, US

(73) Assignees: Jens Mertens, Esslingen (DE); Gunther Holzmacher, Asperg (DE); Jochen Kunze, Moers (DE)

(21) Appl. No.: 11/778,343

(22) Filed: Jul. 16, 2007

(30) Foreign Application Priority Data
Jul. 20, 2006 (DE) 102006034070.1

(51) Int. Cl. F21V 13/04

(52) U.S. Cl. 362/309

(57) ABSTRACT

The invention relates to a light unit with a light-emitting diode comprising at least one non-glowing light source and with a light distribution body optically downstream to the light-emitting chip source, whereby the frontal area of the light distribution body facing away from the non-glowing light source has a hollow and whereby each periphery of the hollow comprises a total reflection surface for the light emitted from the non-glowing light source. For this purpose, the light distribution body is part of the light-emitting diode. The section of the light distribution body adjacent to the non-glowing light source has an elliptical section as an envelope curve in at least one cutting plane, which encompasses the optic axis. A compact light unit with a high degree of optical efficiency is developed with this invention.

### TECHNICAL FIELD

The invention is filed on base of a German Application DE 102006034070.1 which content is herein incorporated by reference.

The invention relates to a light unit with a light-emitting diode comprising at least one non-glowing light source and with a light distribution body optically downstream to the non-glowing light source, whereby the light distribution body has at least two sections arranged in series in an at least approximately parallel oriented zero degree direction to the optic axis of the light unit, whereby the frontal area of the light distribution body facing away from the non-glowing light source has a hollow and whereby each periphery of the hollow comprises a total reflection surface for the light emitted from the non-glowing light source.

### BACKGROUND ART

The optic axis of a light unit is for example the geometric center line of the light emitted from the light unit. In a polar light distribution chart for the light unit, the light source is arranged in the center. In this chart, the intensity of the light is plotted around the light source in the individual segments of the full circle. The light unit is mostly shown in a preferred position in the chart for this. For example, the section of the optic axis which is oriented in the direction of the emission of the light source is plotted in the zero degree direction of the chart. The direction starting from the light source, which is oriented at least approximately parallel to the optic axis, is therefore referred to in the following as the zero degree direction of the light unit.

A light unit with a light-emitting diode is well-known from EP 1 255 132 A1. The light distribution body is placed on the light-emitting diode, whereby the gap between the two bodies can be filled with transparent material. A part of the light is absorbed when passing through the different materials. The light is deflected by 90 degrees. To use this light unit e.g. as a headlamp, a flat reflector with a large diameter is required.

The problem of developing a compact light unit with a high degree of optical efficiency is therefore the purpose of this invention.

This problem is solved with the characteristics of the main claim. For this purpose, the light distribution body is part of the light-emitting diode. The section of the light distribution body adjacent to the non-glowing light source has an elliptical section as an envelope curve in at least one cutting planes which encompasses the optic axis. At least one large semiaxis of this ellipse is arranged in the zero degree direction offset to the non-glowing light source. In addition, the radius of the osculating circle at the final point of the large semiaxis is between 30% and 90% of the length of the large semiaxis.

Further details of the invention ensue from the subclaims and the following description of schematically shown design versions.

### BRIEF DESCRIPTION OF THE DRAWINGS

FIG. 1: Light unit with light-emitting diode;

FIG. 2: Section through FIG. 1;

FIG. 3: Light distribution chart of the light unit in accordance with FIG. 1;

FIG. 4: Light unit with light-emitting diode and reflector.

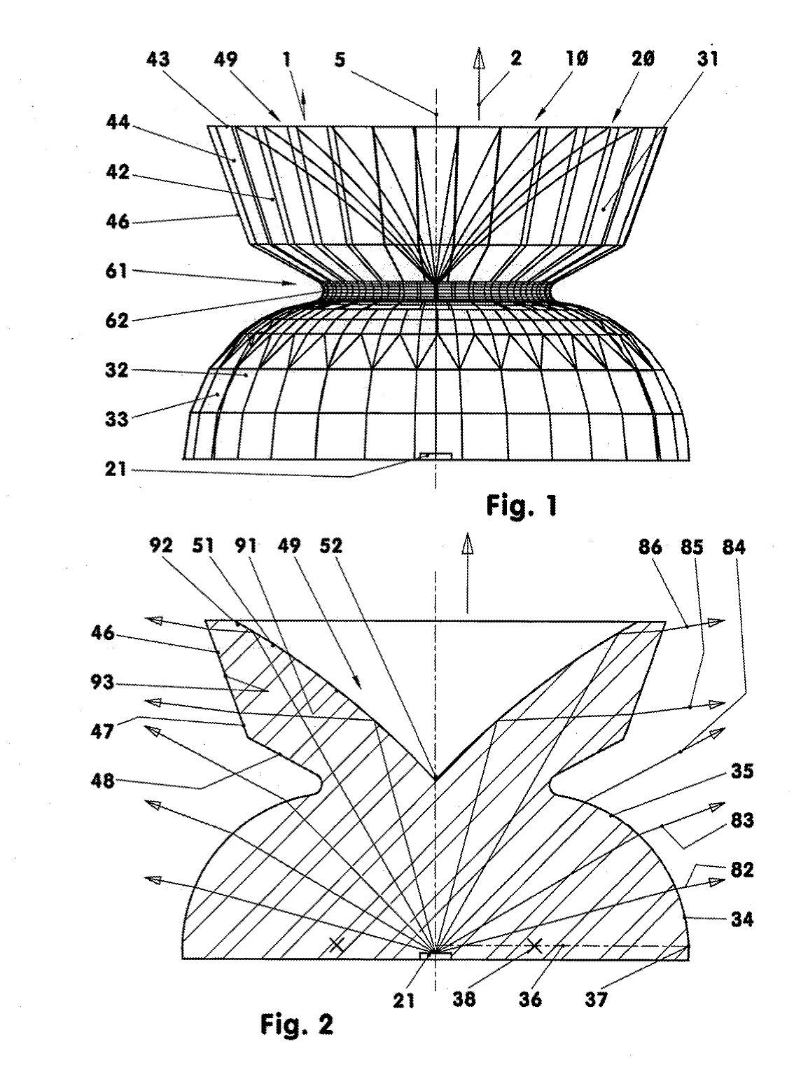

FIG. 1 shows a wire-frame model of a light-emitting diode (20) as an example of a light unit (10). The light-emitting diode (20) comprises a non-glowing light source (21), e.g. a light-emitting chip (21) and a light distribution body (31). The electrical connections of the light-emitting diode (20) are not shown here. In FIG. 2, a section through this light-emitting diode (20) is shown, whereby the cutting plane of this representation encompasses the optic axis (5).

The optic axis (5) of the light unit (10) is for example aligned normally to the light-emitting chip (21) and penetrates the light distribution body (31). The latter is arranged rotationally symmetrical to the optic axis (5) in this design example. The front view of the light distribution body can also be designed square, rectangular, elliptical, etc. In the light distribution chart, the light source is arranged in the center, so that the zero degree direction (2) originates at the light-emitting chip (21). Here it is oriented parallel to the optic axis (5) in the direction of the frontal area (43) of the light distribution body (31), which is facing away from the light-emitting chip (21). In the representation of FIGS. 1-4, the zero degree direction (2) is pointing upwards.

In FIGS. 1 and 2, the light-emitting chip (21) is embedded in the lower area of the light distribution body (31), so that the light distribution body (31) lies against the light-emitting chip (21) and surrounds this.

The light distribution body (31) has e.g. a length of 3 millimeters along the optic axis (5) above the non-glowing light source (21). Its maximum diameter in a plane normal to the optic axis (5) is for example 5 millimeters. The length of the light distribution body (31) in this design example is therefore smaller than 70% of its maximum diameter. The light distribution body (31) can have dimensions larger or smaller than those stated. For instance, the diameter of the light distribution body (31) can e.g. be between 3 and 8 millimeters.

The light distribution body (31) comprises two sections (32, 42) of at least approximately the same length arranged in series in the zero degree direction (2), which are connected with each other by means of a transition area (61) designed as a constriction (62). The lower section (32) shown in FIG. 1 has at least approximately the shape of a hemiellipsoid (33), the center and cutting plane of which lies normal to the optic axis (5). A truncated cone (44) which widens in the zero degree direction (2) sits e.g. on the lower section (32) as the upper section (42). The frontal area (43) of the light distribution body (31) has a central hollow (49). The diameter of the constriction (62) in this design example is 45% of the maximum diameter of the light distribution body (31).

In the sectional view of FIG. 2, the hemiellipsoid (33) is shown as a hemiellipse (34). The in this case horizontally located central axis of the hemiellipse (34) is formed in this design example by two large semiaxes (36) aligned with each other, of which only one is shown in FIG. 2. These large semiaxes (36) lie e.g. parallel to the light-emitting chip (21) and are offset in the zero degree direction (2) to the light-emitting chip (21) for example by 1% of the diameter of the light distribution body (31). The imaginary small semiaxis of the hemiellipse (34) lies on the optic axis (5).

The central points (38) of the osculating circles lie on the large semiaxes (36). These osculating circles are at a tangent to the hemiellipse (34) at least in the final points (37) of the large semiaxes (36). The radius of the osculating circles is for example between 40% and 90% of the length of the large semiaxes (36) of the hemiellipse (34). In the representation of FIG. 2 the radius is 60% of this length. If necessary, the hemiellipse (34) can have an oval shape. The osculating circle is at a tangent to the hemiellipse (34) along a quarter circle. The line limiting the lower section (32) can also encompass a section of a hemiellipse (34), for example in the case of a light distribution body (31), which is a segment of a body rotationally symmetrical to the optic axis (5).

The hemiellipse (34) passes e.g. at a tangent into the constriction (62) designed for example as a hollow molding. Its radius is e.g. 2% of the length of the hemiellipse (34).

The maximum diameter of the truncated cone (44) is for example 90% of the maximum diameter of the light distribution body (31). Its peripheral surface (46) has an upper (47) and a lower area (48). In the upper area (47), the peripheral surface (46) here is inclined by 20 degrees to the optic axis (5). The length of this area (47), measured parallel to the optic axis (5), is e.g. 35% of the length of the light distribution body (31). In the lower area (48) in this design example, the inclination of the peripheral surface (46) to the optic axis (5) is 60 degrees. The peripheral surface (46) can also be designed stepped. The steps then comprise e.g. several surfaces, which are offset to each other and are inclined 20 degrees to the optic axis.

The hollow (49) of the frontal area (43) facing away from the light-emitting chip (21) is designed in a funnel shape and tapers in the direction of the light-emitting chip (21). It runs towards a point (52). Its depth is for example 48% of the length of the light distribution body (31). The largest diameter of the hollow (49) in this design example is 80% of the maximum diameter of the light distribution body (31). The generatrix of the periphery (51) of the hollow (49) in this design example is a parabola, cf. FIG. 2. The focal spot of the parabola lies here in the light-emitting chip (21) presumed e.g. as a pinhead. Instead of a parabola, the generatrix of the hollow (49) can also be a different continuous or section by section continuous geometric curve.

The light-emitting diode (20) is manufactured for example by means of an injection molding process in two processing steps. The material used in the injection molding process in both processing steps is for example a highly transparent thermoplastic, e.g. modified polymethylmethacrylimide (PMMI), polysuflon (PSU), silicone, etc. In the first processing step, the light-emitting chip (21) is surrounded with an electronic protective body not shown here. In the second processing step, this is extruded to form the light distribution body (31). This therefore results in a homogeneous light distribution body (31), which lies directly against the light-emitting chip (21). The light-emitting diode (20) can also be manufactured in a single processing step. If necessary, the shape of the surface of the light distribution body (31) can in addition be changed by means of a forming operation.

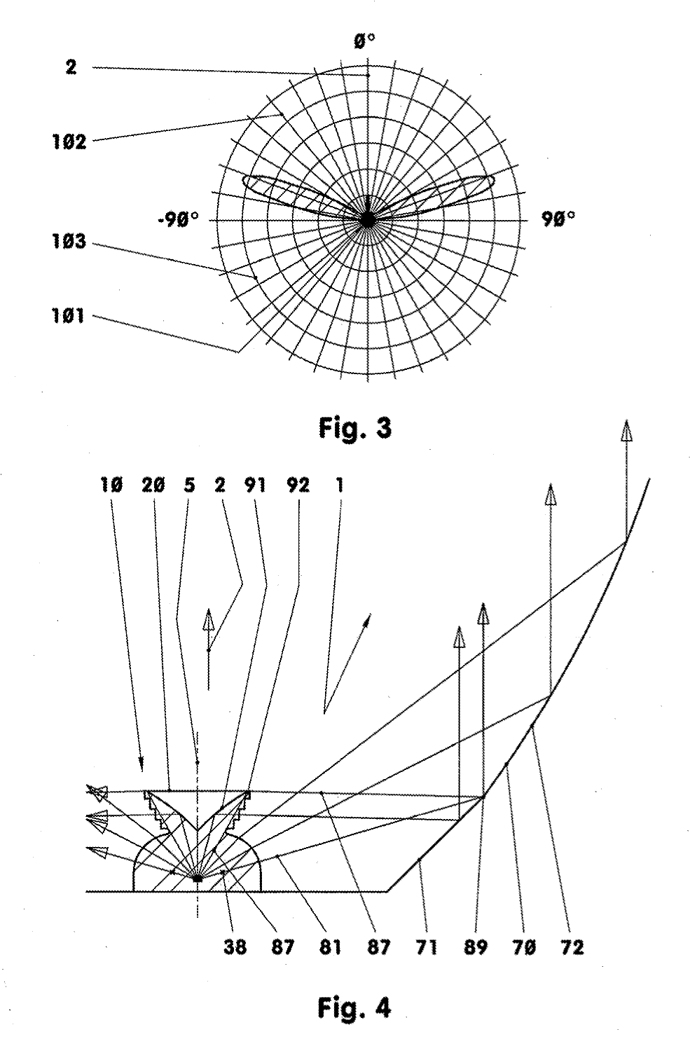

During the operation of the light-emitting diode (20), the light-emitting chip (21) presumed here as a pinhead emits light as a Lambertian source at least approximately in a half-space. By way of example, FIG. 2 shows individual beams of light (82-86) offset to each other by 15 degrees. Light (82-84) which is emitted at an angle between e.g. 85 degrees and 35 degrees to the optic axis (5) hits the interface (35) of the hemiellipsoid (33). In this case, the angle of 85 degrees is the angle of the imaginary beam of light, which goes through the central point (38) of the osculating circle. When it hits the interface (35), the light (82-84) takes in an angle with the normal line in the point of impact, which is smaller than the critical angle of the total reflection. In this case, this critical angle is for example 43 degrees. The light (82-84) penetrates through the interface (35). On crossing over from the optically thicker material of the light distribution body (31) into the optically thinner surroundings (1), e.g. air, the light (82-84) is deflected from the perpendicular. In the design example shown here the index of refraction is 1.635. The light emitted from the light-emitting chip (21) in the above-mentioned angle segment now emerges in an angle segment of for example 62 degrees to 85 degrees to the optic axis (5) into the surroundings (1). The interface (35) of the hemiellipsoid (33) therefore acts as a converging lens for the light emitted from the light-emitting chip (21). In a polar represented light distribution chart, cf. FIG. 3, a high luminous intensity results in this segment.

The interface (35) of the hemiellipsoid (33) can be designed in the form of a Fresnel lens. For instance, it can comprise individual rotating rings designed as Fresnel elements. The theoretical envelope shape of such a Fresnel lens is the converging lens described above.

Light (85, 86), which is emitted from the light-emitting chip (21) at an angle to the optic axis (5), which is smaller than 35 degrees, travels to the periphery (51) of the hollow (49). The light (85, 86) hits this periphery (51) at an angle to the normal line in the point of impact, which is larger than the critical angle of the total reflection. The periphery (51) forms a total reflection surface (91) for the impinging light (85, 86), on which the impinging light (85, 86) is reflected in the direction of the peripheral surface (46). A small proportion of the light emitted from the light-emitting chip (21) penetrates through the point (52) of the hollow (49) into the surroundings (1).

The total reflection surface (91) can for example be made up of individual surface entities. The connecting line of the surface entity to the light-emitting chip (21) then takes in an angle with the normal line in this surface entity, which is larger than the critical angle of the total reflection. The periphery (51) of the hollow (49) can also be vaporized. It can be larger than the total reflection surface (91).

In this design example, the beams of light (85, 86) reflected on the total reflection surface (91) are at least approximately parallel to each other. The light hits the peripheral surface (46) at an angle to the normal line in the point of impact, which is smaller than the critical angle of the total reflection. On penetrating through the peripheral surface (46), which forms a refraction surface (93), it is deflected from the perpendicular. In the design example shown here, the light (85, 86) emerges at an angle of 75 degrees to the optic axis (5) into the surroundings (1). The peripheral surface (46) can also be arranged in such a way that the reflected light (85, 86) penetrates it without refraction.

The light (85, 86) emerging from the upper section (42) overlaps with the light (82, 84), which emerges from the lower section (32) of the light distribution body (31). The light emitted from the light-emitting chip (21) is deflected. The maximum of the light intensity is for example in an area around 75 degrees to the optic axis (5). Due to the homogeneous material of the light distribution body (31) and the low refraction losses, the light unit (10) described here has a high level of efficiency.

The transition area (61) between the lower section (32) and the upper section (42) of the light distribution body (31) is for example defined in such a way that in the representation of FIG. 2 a beam of light at a tangent to the transition area (61) hits the upper end of the periphery (51). In this respect, the imaginary peripheral line at the upper end of the periphery (51) is determined amongst other things by the refractive index and the desired angle of light emission of the lower section (32). For example, in the case of a horizontal transition between the lower section (32) and the transition area (61) and a desired angle of light emission Alpha of the limiting beam of light from the lower section (32) to a horizontal plane, the critical angle (Alpha+x) of the peripheral line of the periphery (51) to a horizontal plane is derived from:

sin(x)/(n−cos(x))=tan(90°-alpha)−tan(x)/(1+(tan(90°-alpha)*tan(x))

In this formula, n is the refractive index of the material of the lower section (32). The origin of the angle Alpha is the penetration point of the beam of light through the interface (35) of the lower section (32). The origin of the critical angle (Alpha+x) is the light-emitting chip (21). The critical angle of the periphery (51) established in this way also determines the peripheral surface (46) of the upper section (42).

FIG. 3 shows the polar light distribution chart for the light unit (10) shown in FIGS. 1 and 2. The angles of radiation are shown as radians (102), whereby the direction pointing upwards here is the zero degree direction (2). Circles (103) concentric to each other are arranged on the radians (102). These show luminous intensity values diminishing from the center (101) to the outside, e.g. in candela per kilolumen. In this polar light distribution chart, this therefore results in a maximum of the intensity in an area around 75 degrees to both sides of the zero degree direction (2) for the light emerging from the light distribution body (31). The intensity diminishes both at smaller angles and at larger angles.

To construct a light unit (10), the maximum of intensity of which lies in a segment which is smaller than 75 degrees, the center line of the hemiellipsoid (33) is for example moved away from the light-emitting chip (21) in the zero degree direction (2). At the same time, the angle of inclination of at least the upper area (47) of the peripheral surface (46) to the optic axis (5) can for example be increased.

If the maximum of intensity is to lie e.g. at an angle of 85 degrees to the optic axis (5), the center line of the hemiellipsoid (33) can be arranged closer to the light-emitting chip (21). At the same time, the angle of inclination e.g. of the upper area (47) of the peripheral surface (46) to the optic axis (5) can be reduced.

To produce a light unit (10) with a narrow radiation segment, a large distance of the central points (38) of the osculating circles to the light-emitting chip (21) can for example be selected. Conversely, for a wide radiation segment the central points (38) of the osculating circles can be placed close to the light-emitting chip (21). To adjust the desired light distribution chart, a variation of the osculating circle radii and, as such, the curvature of the ellipsoid (33) is conceivable.

A light unit (10) with a light-emitting diode (20) and a reflector (70) optically downstream to the light-emitting diode (20) is shown in FIG. 4.

The light-emitting diode (20) corresponds to a large extent to the light-emitting diode (20) shown in FIGS. 1 and 2. In the design example shown here, the refractive index of the material of the light distribution body (31) however is 1.4 for example. The light (81-87) emerging from the light-emitting diode (20) sweeps a segment here of 50 degrees to 90 degrees to the optic axis (5).

The reflector (70) is designed in a concave shape and constructed e.g. coaxially to the optic axis (5). The light-emitting diode (20) sits in its center. It comprises two reflection areas (71, 72) here. An inner cone-shaped area (71) is surrounded by an external, e.g. parabolically designed area (72). In this case, the cone-shaped area (71) is for example inclined by 45 degrees to the optic axis (5).

The beam of light (81) which goes through the central point (38) of the osculating circle of the hemiellipse (34) is shown in the sectional view of FIG. 4. This beam of light (81) hits the interface (35) normally and is not broken on penetrating through the interface (35). The inclination of the beam of light (81) emerging into the surroundings (1) to the optic axis (5) is for example 85 degrees.

Furthermore, the beam of light (87) which is at a tangent to the constriction (62) is shown in this FIG. 4. This beam of light (87) is the beam of light (87) with the largest angle of inclination towards the optic axis (5), which hits the total reflection surface (91). It is reflected at the end (92) of the total reflection surface (91) away from the light-emitting chip (21) in the direction of the peripheral surface (46) and penetrates the peripheral surface (46) for example without refraction. The inclination of the beam of light (87) emerging into the surroundings (1) to the optic axis (5) is for example 90 degrees.

The two beams of light (81, 87) described intersect in the sectional view of FIG. 4 in a point (89), which lies for example on the reflector (70). At this point (89) the conical area (71) passes into the parabolic area (72). In a three-dimensional space, this point (89) is a point of a line, which has e.g. a constant distance to the light distribution body (31). In the case of a light-emitting diode (20) with a rotationally symmetrical light distribution body (31), this line is a circle, the central point of which lies e.g. on the optic axis (5). The transition of the two reflector areas (71, 72) can have a larger distance to the light-emitting diode (20) than the line (89).

Light (85, 86), which is emitted from the light-emitting chip (21) at an angle to the optic axis (5), which is smaller than the angle of inclination of the beam of light (87), hits the cone-shaped area of the reflector (70). The light (85, 86) is reflected there in the zero degree direction (2). The individual beams of light (85, 86) are now for example parallel to each other.

The light (82-84), which is emitted from the light-emitting chip (21) into an angle segment, which is limited by the angles of inclination of the emitted beams of light (81) and (87), hits the parabolic area (72) of the reflector (70). It is reflected here in the zero degree direction (2).

Viewed from a distance, this therefore results in a largely homogeneous luminous light unit (10) without any dark spots.

The reflector (70) can also be designed with a single conical or a single arched area. With this, a diffuse proportion of the light emitted from the light unit (10) can for example be specifically produced. Designing the reflector (70) parabolically in the basic form is also conceivable. Pillow-like elevations and/or depressions are then arranged on the reflector surface for example.

All of the light emerging from the light unit (20) is distributed on a large surface of the reflector (70) and reflected there. Minor inaccuracies of the coating of the reflector (70) do not interfere with the light emitted from the light unit (10). The reflector (70) used can therefore be manufactured in a diameter range in which e.g. the coating can be produced reliably and accurately.

The light unit (10) has therefore been designed compactly and is highly efficient.

The light unit (10) can also be designed in such a way that in a view from the frontal area (43) the reflector (70) and/or the light distribution body (31) is a segment of a rotationally symmetrical body. A square, rectangular, limited by a polygon function, etc. shape of the light distribution body (31) and/or of the reflector (70) is also conceivable. The light-emitting diode (20) can also comprise several light-emitting chips (21).

Combinations of the various design examples are also conceivable.

### LIST OF REFERENCE MARKS

1 surroundings
2 zero degree direction
5 optic axis
10 light unit
20 light-emitting diode
21 non-glowing light source, light-emitting chip
31 light distribution body
32 lower section of (31)
33 hemiellipsoid
34 hemiellipse
35 interface of (33)
36 large semiaxis of (34)
37 final point of (36)
38 central points of the osculating circles
42 upper section of (31)
43 frontal area
44 truncated cone
46 peripheral surface of (44)
47 upper area of (46)
48 lower area of (46)
49 hollow
51 periphery of (49)
52 point of (49)
61 transition area
62 constriction
70 reflector
71 reflection area, cone-shaped area
72 reflection area, parabolically designed part
81 beam of light through (38)
82-86 beams of light
87 beam of light at a tangent to (62)
89 intersection of (81, 87), intersection line
91 total reflection surface
92 end of (91), facing away from (21)
93 refraction surface
101 center
102 radians
103 lines, circles

1. Light unit with a light-emitting diode comprising at least one non-glowing light source and with a light distribution body optically downstream to the non-glowing light source, wherein the light distribution body has at least two sections arranged in series in an at least approximately parallel oriented zero degree direction to the optic axis of the light unit, whereby the frontal area of the light distribution body facing away from the non-glowing light source has a hollow and wherein each periphery of the hollow comprises a total reflection surface for the light emitted from the non-glowing light source, characterized by
the light distribution body being pad of the light-emitting diode,
the section of the light distribution body adjacent to the non-glowing light source having an elliptical section as an envelope curve in at least one cutting plane, which encompasses the optic axis,
at least one large semiaxis of this ellipse being arranged in the zero degree direction offset to the non-glowing light source and
the radius of the osculating circle at the final point of the large semiaxis being between 30% and 90% of the length of the large semi-axis.

2. Light unit according to claim 1, wherein the light distribution body is rotationally symmetrical to the optic axis of the light unit.

3. Light unit according to claim 1, wherein the section has at least approximately a truncated cone-shaped form, whereby the cone widens in the zero degree direction.

4. Light unit according to claim 1, wherein the center plane of the hemiellipsoid is offset to the non-glowing light source by at least 1% of the diameter of the light-emitting diode.

5. Light unit according to claim 1, wherein the length of the light distribution body of the light-emitting diode above the non-glowing light source is a maximum of 70% of its diameter.

6. Light unit according to claim 1, wherein the diameter of the light distribution body is smaller than 8 millimeters.

7. Light unit according to claim 1, wherein the total reflection surface is optically downstream to at least one refraction surface.

8. Light unit according to claim 1, wherein a reflector is optically downstream to the light-emitting diode.

9. Light unit according to claim 8, wherein the reflector encompasses a cone-shaped area and a parabolically designed area.

10. Light unit according to claim 8, wherein the beams of light, on which the central points of the osculating circles lie and the beams of light, which are reflected at the end of the total reflection surface away from the light-emitting chip, intersect in at least one line.

11. Light unit according to claim 2 wherein the line is a circle, whereby the central point of the circle lies on the optic axis.

12. Light unit according to claims 9, wherein the transition between the conical and the parabolic part of the reflector lies at least approximately on this circle.
